(19) United States
(12) Patent Application Publication
(10) Pub. No.: US 2018/0236823 A1
(43) Pub. Date: Aug. 23, 2018

(54) Pneumatic Vehicle Tyres

(71) Applicant: Continental Reifen Deutschland GmbH, Hannover (DE)

(72) Inventors: Oliver Schürmann, Langenhagen (DE); Andreas Tyburski, Ilsede (DE); Eduarda Gomes, Santo Tirso (PT); Tomas Gargulak, Slusovice (CZ)

(73) Assignee: Continental Reifen Deutschland GmbH, Hannover (DE)

(21) Appl. No.: 15/752,744

(22) PCT Filed: Apr. 12, 2016
(86) PCT No.: PCT/EP2016/057961

§ 371 Date: Feb. 14, 2018

(30) Foreign Application Priority Data
Aug. 18, 2015 (DE) 10 2015 215 738.5

(51) Int. Cl. B60C 19/00; B29D 30/00

(52) U.S. Cl. CPC B60C 19/002; B60C 17/0009; B29D 30/0061

(57) ABSTRACT

The invention relates to a pneumatic vehicle tire (1) having a profiled tread (2) that merges at either side into sidewalls (3, 4), the end of which is formed by a tire bead (5, 6) insertable in an airtight manner into a wheel rim (7) of a vehicle wheel (8), wherein an absorber (10) cohesively bonded to the inner surface (9) of the pneumatic vehicle tire (1) has been integrated into the pneumatic vehicle tire (1) for sound absorption and the cohesive bonding consists of a bonding agent (11) in an arrangement where it is not distributed over the full area between the absorber (10) and the inner surface (9) of the pneumatic vehicle tire (1).

The invention relates to a pneumatic vehicle tire as per the preamble of patent claim 1.

A pneumatic vehicle tire of the type in question here can be used either for bicycles or for passenger vehicles, agricultural vehicles and/or heavy goods vehicles, the vehicle wheels of which have been equipped with pneumatic vehicle tires, wherein the pneumatic vehicle tires have a structured tread having a profile suitably adapted to the expected ground surfaces and weather conditions. In a manner known per se, the tread of the pneumatic vehicle tire merges at either side into sidewalls, each end of which is formed by a tire bead. The tire bead serves for airtight fixing of that part of the pneumatic vehicle tire which is made up of different rubber mixtures with a wheel rim of the vehicle wheel to be equipped with the pneumatic vehicle tire. In a manner which is likewise known, the wheel rim, in a corresponding manner to the tire bead, has a wheel rim edge against which the tire bead bears in a sealing manner when the air cavity enclosed by the tubeless pneumatic vehicle tire and the wheel rim is filled with compressed air.

Modern pneumatic vehicle tires must nowadays not only transmit the kinetic energy generated by the motor vehicle to the ground surface in an optimal manner at all times under changing environmental conditions, but must increasingly also satisfy elevated demands with regard to comfort. In this context, a crucial role is also played by the rolling noise of the pneumatic vehicle tire which is generated by the vibration of the air when the latter is compressed as the pneumatic vehicle tire is compressed against the road surface. The rolling noise that arises in this way is transmitted from the pneumatic vehicle tire to the wheel hub, such that it ultimately passes through the steering system and the suspension arrangement into the passenger compartment. However, acoustic exposure to the rolling noise generated during driving is perceived as a nuisance not only within but also outside the motor vehicle, which is becoming increasingly significant in cities for example.

Rolling noise can be significantly reduced by means of technology which is already known and is in use in some motor vehicles. This involves using, as a sound-absorbing medium, an absorber which is arranged within the pneumatic vehicle tire and is frequently executed as a foam body, which is cohesively mounted, i.e. with an adhesive for example, on the inside of the tread of the pneumatic vehicle tire. There are also known solutions in which the absorber is secured to the wheel rim of the vehicle wheel. The structure of this absorber, which generally consists of polyurethane, is maintained even under extreme temperature variations. Polyurethanes are plastics or synthetic resins which form from the polyaddition reaction of dialcohols or polyols with polyisocyanates. Depending on the type of motor vehicle, the speed thereof and the road surface, it is possible by means of the aforementioned measures to achieve reductions in vehicle noise in the interior of the motor vehicle by up to 9 dB(A), with no restriction in either the driving characteristics or the performance, the load-bearing capacity or the speed achievable with the pneumatic vehicle tire as a result of the introduction of the absorber into the pneumatic vehicle tires.

Such a pneumatic vehicle tire of a vehicle wheel is known, for example, from DE 10 2007 028 932 A1. The document states that the absorber executed as a foam body is secured within the pneumatic vehicle tire with a pre-applied, automatically sealing sealant with bonding on the inner surface of the pneumatic vehicle tire. The sealant used here, which is adhesive-bonded over the full area, is a polyurethane gel.

In addition, DE 198 06 953 C2 discloses a pneumatic vehicle tire suitable for a vehicle wheel and a method of producing a pneumatic vehicle tire of this kind, wherein the absorber likewise executed as a foam body, even before being applied on the inner surface of the pneumatic vehicle tire, is produced in a form suitable for the purpose by means of a foaming process and is then equipped with an additional, sound-absorbing structure on the side facing the inside of the pneumatic vehicle tire. The structure applied to the foam layer here may be in linear form or wavy form, each of which is suitable for providing an increased surface area that additionally has a sound-absorbing effect.

What is important is that there has to date always been adhesive bonding over the full area between the absorber and inside of the pneumatic vehicle tire because the view is generally expressed that only full-area bonding can provide sufficient certainty against unwanted, automatic detachment of the absorber from the inner surface of the pneumatic vehicle tire. Moreover, it was regarded as the simplest solution in terms of manufacturing technology to provide the entire inner surface of the pneumatic vehicle tire with an adhesion promoter or bonding agent and then to fix the absorber on the section of the inner surface intended for the purpose. It has now been found that, however, full-area bonding brings drawbacks with regard to the weight of the pneumatic vehicle tire and hence affects the driving properties of a vehicle wheel equipped with pneumatic vehicle tire, even if the effect is comparatively small. Furthermore, the cost and inconvenience involved in preparation for the bonding and here especially the cost and inconvenience of cleaning to free the surfaces to be bonded of impurities is relatively high, and so a reduction here would be desirable. Ultimately, full-area bonding also requires a considerable amount of bonding agent, which is economically disadvantageous.

It is an object of the invention to provide a pneumatic vehicle tire with an absorber suitable for sound absorption, in which the bonding between the absorber and pneumatic vehicle tire is optimized and saves weight to a maximum degree, and is simple to implement in terms of manufacturing technology.

This objective is achieved by the invention with the features of claim 1.

Further configurations of the invention are the subject of the subsequent dependent claims.

A pneumatic vehicle tire having a profiled tread that merges at either side into sidewalls, the end of which is formed by a tire bead insertable in an airtight manner into a wheel rim of a vehicle wheel, wherein an absorber has been integrated into the pneumatic vehicle tire for sound absorption, has been developed in accordance with the invention in that the cohesive bonding consists of a bonding agent in an arrangement where it is not distributed over the full area between the absorber and the inner surface of the pneumatic vehicle tire.

The solution of the invention of providing adhesive bonding not over the full area between the absorber and the inner surface of the pneumatic vehicle tire achieves multiple advantages at the same time. Thus, firstly, the saving of costly bonding agent constitutes an economic benefit which additionally also leads to a reduction in the total weight of the pneumatic vehicle tire and hence also of the vehicle wheel equipped with the pneumatic vehicle tire, which ultimately also has a positive overall effect on the fuel consumption of the motor vehicle. Furthermore, manufacturing-related advantages also arise, because both the preparation of the surfaces to be bonded and the bonding operation as such are significantly simplified, such that pneumatic vehicle tire is equipped in such a way that it can be manufactured within a shorter time and hence produced more economically.

In a first configuration of the invention, the bonding agent has a homogeneously repeating distribution around the circumference of the inner surface of the pneumatic vehicle tire. In other words, the bonding agent is applied in a constantly recurring, identical pattern either to the inner surface of the pneumatic vehicle tire and/or to the bonding agent surface of the absorber. The homogeneous application of the bonding agent even enables automated handling of the bonding operation, which in turn reduces the manufacturing complexity for a pneumatic vehicle tire produced in this way.

As an alternative to this proposal, in another, very advantageous solution according to the invention, the bonding agent has an inhomogeneous, varying distribution around the circumference of the inner surface of the pneumatic vehicle tire. In this method of application of the bonding agent, no particular pattern and no particular sequence of the application of the bonding agent to the inner surface of the pneumatic vehicle tire and/or to the bonding agent surface of the absorber is envisaged. The bonding agent here can consequently be applied randomly or, in a manner corresponding to a preferred variant, a defined sequence of application of the bonding agent is envisaged, but there is a change in the profile of the bonding agent applied along the inner surface of the pneumatic vehicle tire or along the surface of the absorber.

For instance, in accordance with a continuation of this idea of the invention, the bonding agent may consist of a strip pattern, take the form of wavy lines or form a dot matrix. The examples which follow for the application of the bonding agent are based either on the circumferential direction of the pneumatic vehicle tire or the direction transverse to the circumference of the pneumatic vehicle tire.

A crucial factor for the selection of the outline of the bonding agent application, in accordance with the invention, is that the bonding agent applied has gaps, in such a way that the absorber and the pneumatic vehicle tire are reliably and permanently firmly bonded to one another and, at the same time, a maximum amount of bonding agent is saved.

The application of the bonding agent in the form of wavy lines may extend here over the entire width of the absorber, i.e. transverse to the circumferential direction of the pneumatic vehicle tire, or at least over a significant portion of the width of the absorber.

Considering the form of wavy lines, for example, viewed in circumferential direction of the pneumatic vehicle tire, this may consist of homogeneous bonding agent application, i.e. in a nearly sinusoidal wave.

In another variant of this form of wavy lines, the individual, mutually alternating wave peaks and wave troughs of the bonding agent application have increasing or decreasing distances from one another.

The dot matrix in the sense of the invention should be understood such that the bonding agent is distributed in the form of dots over the inner surface of the pneumatic vehicle tire or over the surface of the absorber. Stated in simpler terms, the bonding agent is dabbed onto at least one of the contact surfaces.

With regard to the strip pattern, there are numerous different variants of the application of the bonding agent to the inner surface of the pneumatic vehicle tire or to the corresponding bonding agent area of the absorber. This may be understood to mean, for example, a strip pattern wherein the strips each have equal or unequal distances or equal or unequal dimensions. Furthermore, the strip pattern may also form a lattice structure, such that various strips cross on the surface to be provided with bonding agent.

In a further variant, successive bonding agent strips in circumferential direction of the pneumatic vehicle tire have different widths or the distances between the bonding agent strips are of different width. Moreover, the strip pattern mentioned is also understood to mean an execution in which every two successive bonding agent strips, viewed at right angles to the circumferential direction of the pneumatic vehicle tire, have an offset relative to one another. These and numerous further options for the arrangement of the bonding agent are encompassed by the concept of the invention and cannot be mentioned over their full extent at this point owing to their variety.

As well as the aforementioned very different geometries that the application of bonding agent can have, it is also possible in accordance with the invention to provide the volume of the bonding agent along the circumference of the inner surface or in the direction transverse to the circumference of the inner surface of the pneumatic vehicle tire with a homogeneous or varying distribution, such that the bonding agent can also have regions with thickenings. In this case, either the geometry of the bonding agent strips is varied or the volume thereof. Stated in simpler terms, sections having increased application of bonding agent and sections having reduced application of bonding agent are provided on the inner surface of the pneumatic vehicle tire or the corresponding surface of the absorber. The sections having increased application of bonding agent are preferably in the regions of the expected maximum stress of the surfaces to be contacted with one another.

It is a further feature of the invention that the total bonding agent area between the inner surface of the pneumatic vehicle tire and the absorber is between 10% and 90% of the projected area of the absorber. In order to illustrate this, it should be noted here that, for example, in the case of a total bonding agent area of 80% between the inner surface of the pneumatic vehicle tire and the absorber, 20% of the projected area of the absorber accordingly remains clear, i.e. is not provided with a bonding agent. With these values, it is already possible to achieve very good results.

By contrast with this, in a preferred variant, the total bonding agent area between the inner surface of the pneumatic vehicle tire and the absorber is between 30% and 70% of the projected area of the absorber.

In accordance with a very specific, delimiting solution, it is even the case that that the total bonding agent area between the inner surface of the pneumatic vehicle tire and the absorber is between 40% and 50% of the projected area of the absorber. In other words, according to this proposal, only about half of the total bonding agent area is provided with a bonding agent. The remaining half is and remains free of bonding agent. This procedure has achieved the best result to date.

Prior to the bonding to the absorber, the bonding agent is applied either to the bonding agent area of the absorber or to the inner surface of the pneumatic vehicle tire. In the case of application of the bonding agent to the inner surface of the pneumatic vehicle tire, the aim to date has predominantly been application corresponding exactly to the bonding agent area of the absorber. This entails high manufacturing accuracy and is consequently relatively costly and inconvenient. It has now been found that it constitutes a significant simplification of the manufacture of a pneumatic vehicle tire when the application of bonding agent is effected on the inner surface of the pneumatic vehicle tire and the bonding agent is applied not just within the project area of the absorber but also indiscriminately beyond that.

A particularly suitable bonding agent has been found to be polyurethane gel, which is used with preference for the implementation of the invention.

A very specific peculiarity of a pneumatic vehicle tire of the invention is that the ratio f(x) of bonding agent area to projected area in each area component X*Y conforms to the following function:

$$f ( x ) = \frac{1}{2} {\sum }_{n = 0}^{m} ( {a}_{n} \frac{{x}^{n}}{{U}^{n}} + \frac{{b}_{n}}{2} ( 1 + sin \frac{{u}_{n} x}{U} ) + {c}_{n} {e}^{- {v}_{n} \frac{x}{U}} ) / {\sum }_{n = 0}^{m} ( {a}_{n} + {b}_{n} + {c}_{n} ) ++ \frac{1}{2} {\sum }_{n = 0}^{m} ( {g}_{n} \frac{{y}^{n}}{{B}^{n}} + \frac{{h}_{n}}{2} ( 1 + sin \frac{{j}_{n} y}{B} ) + {i}_{n} {e}^{- {k}_{n} \frac{y}{B}} ) / {\sum }_{n = 0}^{m} ( {g}_{n} + {h}_{n} + {i}_{n} )$$

and X and Y are coordinates in circumferential and transverse direction of the pneumatic vehicle tire (1) and:

0<=X<=U

0<=Y<=B

0<=x<=U

0<=y<=B

Vn>0.

Here, “aₙ”, “bₙ”, “cₙ” and “uₙ” are freely selectable parameters. The bonding agent may also constitute any desired combination of one or more of the aforementioned variants.

The invention will be discussed in detail hereinafter with reference to the appended drawings. The working examples shown do not constitute a restriction to the variants described, but serve merely for elucidation of a principle of the invention.

Identical or similar components are always denoted by the same reference designations. To be able to illustrate the function according to the invention, the figures merely show highly simplified diagrammatic illustrations, in which components not essential to the invention have been omitted. However, this does not mean that such components are not present in a solution according to the invention.

The figures show:

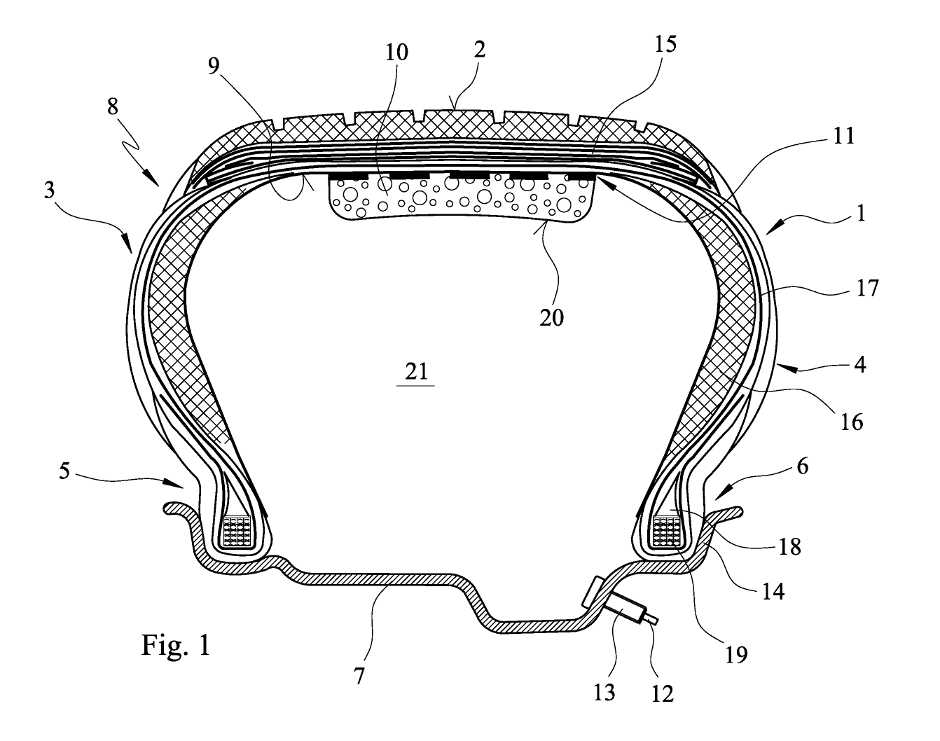

FIG. 1: a fully mounted vehicle wheel in cross section and

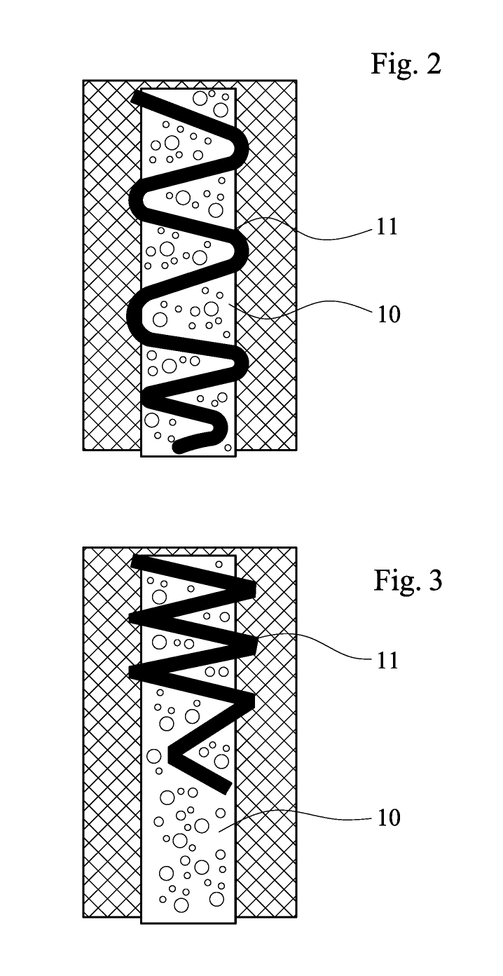

FIGS. 2-18: various illustrations of options for bonding agent application.

FIG. 1 shows, by way of example, a fully mounted vehicle wheel 8 in cross section. The latter is made up of a pneumatic vehicle tire 1 and a wheel rim 7 which holds the pneumatic vehicle tire 1. The pneumatic vehicle tire 1 itself is composed of a profiled tread 2, the profile of which is merely indicated in the illustration in FIG. 1 by multiple groove-like depressions. Below said tread 2, the pneumatic vehicle tire 1 has multiple belt plies 15 which, in FIG. 1, are likewise illustrated merely by way of indication. On either side of the tread 2, the pneumatic vehicle tire 1 also merges into one sidewall 3 and 4 in each case, the lower end of which is formed in each case by a tire bead 5 and 6. Each tire bead 5, 6 is composed of a bead core 19, which merges into a core profile 18 which is encased with a rubber material. The tire beads 5, 6 of the pneumatic vehicle tire 1 form a seal with respect to the surroundings, such that said tire beads 5, 6 bear in air-tight fashion against a wheel-rim edge 14 of the wheel rim 7. The pneumatic vehicle tire 1 and the wheel rim 7 thus jointly surround an air cavity 21, which is filled with compressed air via the valve 12, inserted into a valve shank 13, of the vehicle wheel 8. The sidewalls 3, 4 of the pneumatic vehicle tire 1 are, in a manner known per se, made up of multiple plies, and thus form a complex system for stabilizing the pneumatic vehicle tire 1. Thus, on the inside of each sidewall 3, 4, there is firstly a reinforcing profile 16, which is adjoined in the direction of the outer side of each sidewall 3, 4 by a carcass 17, which in turn is embedded into a rubber layer that is otherwise unspecified in FIG. 1. Furthermore, the sidewall may comprise additional individual plies, which will however not be discussed in any more detail here.

The FIG. 1 shows the special feature of the invention, which is that there is an absorber 10 arranged on the inner surface 9, which is situated opposite the tread 2, of the pneumatic vehicle tire 1. Said absorber 10 is cohesively bonded to the inner surface 9 of the pneumatic vehicle tire 1 using a bonding agent 11. As indicated by the representation in FIG. 1, the bonding agent 11 in the present case has multiple interruptions and, in the example, has been applied in circumferential direction of the pneumatic vehicle tire 1 in linear form to the inner surface 9 of the pneumatic vehicle tire 1 before the absorber 10 has been applied to the inner surface 9 with a corresponding area of bonding agent. In the example, it is important that, especially in the lateral edge regions of the absorber 10, there is a strip of bonding agent 11 in each case, in order more particularly to prevent automatic detachment of the absorber 10 from the inner surface 9 of the pneumatic vehicle tire 1 in these critical regions in particular.

FIGS. 2-18 show, albeit not conclusively, different options for the arrangement of the bonding agent 11, each of the examples shown having an application of bonding agent on the inner surface 9 of the pneumatic vehicle tire 1 and showing the view of a section profile between the bonding agent 11 and the inner surface 9 of the pneumatic vehicle tire 1 looking toward the corresponding bonding agent face of the absorber 10.

FIG. 2 first illustrates a wavy line form of the bonding agent 11 in the direction of the circumference of the pneumatic vehicle tire 1, in which some of the wavy lines of the bonding agent 11 have a virtually sinusoidal shape and some have a geometry differing from the sinus shape of the wavy line.

FIG. 3 shows a zigzag-shaped or sawtooth-like arrangement of the bonding agent 11 in circumferential direction of the pneumatic vehicle tire 1. Here too, sections having homogeneous distances between the individual geometries are present, as are sections having varying distances between the individual geometries of the bonding agent 11.

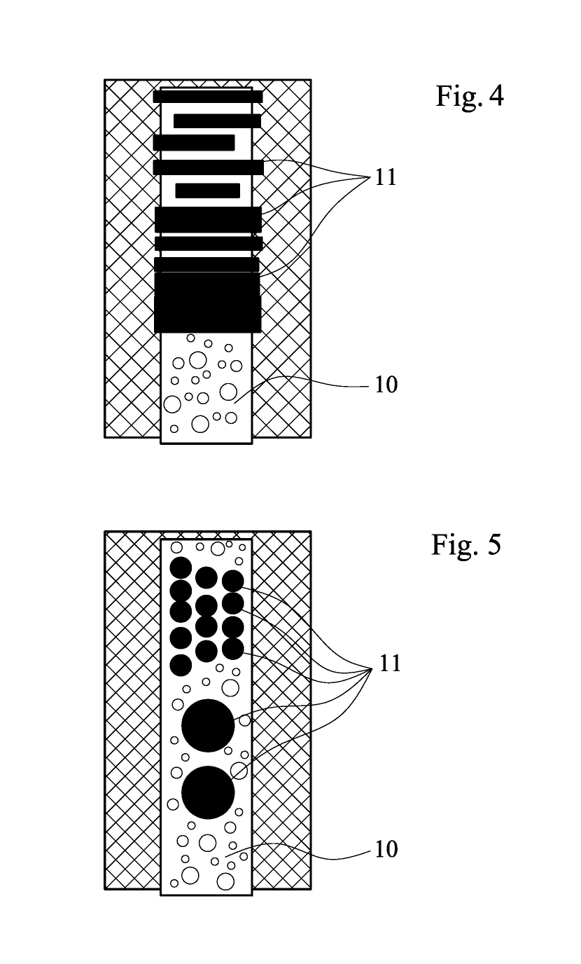

A particular pattern of the arrangement of the bonding agent 11 is shown by FIG. 4. In this case, the bonding agent 11 has been applied in strips, giving rise to a barcode-like geometry as a result of the different thicknesses and the different distances between the individual bonding agent strips 11 viewed in circumferential direction of the pneumatic vehicle tire 1.

FIG. 5 shows various variations of a dot matrix, wherein it is possible either for a multitude of smaller dots to be provided in random or homogeneous arrangement or for a small number of dots of the bonding agent 11 of enlarged geometry to be present at homogeneous or inhomogeneous distances. It is likewise also possible to vary the volume of bonding agent applied with a dot matrix of this kind.

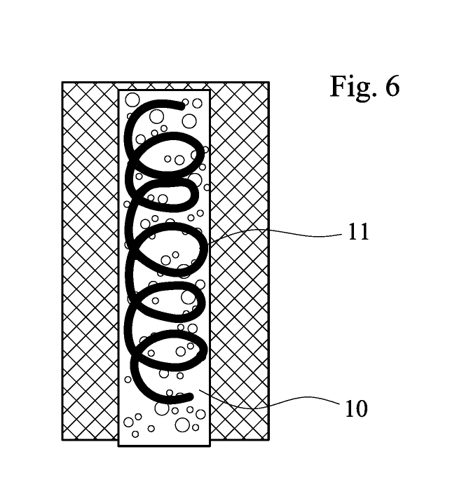

FIG. 6 illustrates a wiggly line or spiral form of the bonding agent 11 in the circumferential direction of the pneumatic vehicle tire 1.

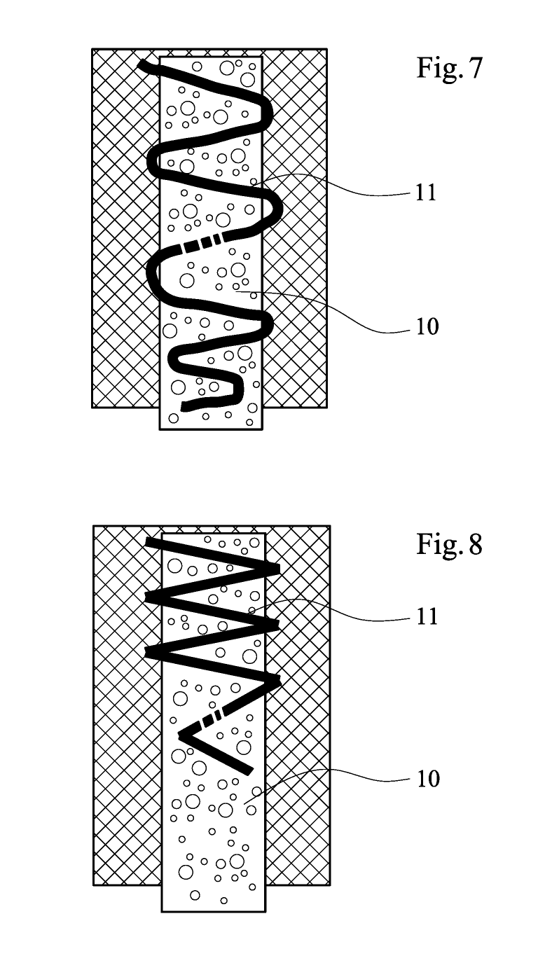

FIG. 7 again shows, viewed in circumferential direction of the pneumatic vehicle tire 1, a wavy line form of the bonding agent 11, where interruptions are present here in the line of the bonding agent 11.

In an analogous manner, the diagram in FIG. 8 shows the zigzag-shaped or sawtooth-like arrangement of the bonding agent 11 that has already been described above, in which there are likewise some interruptions in the line of the bonding agent 11.

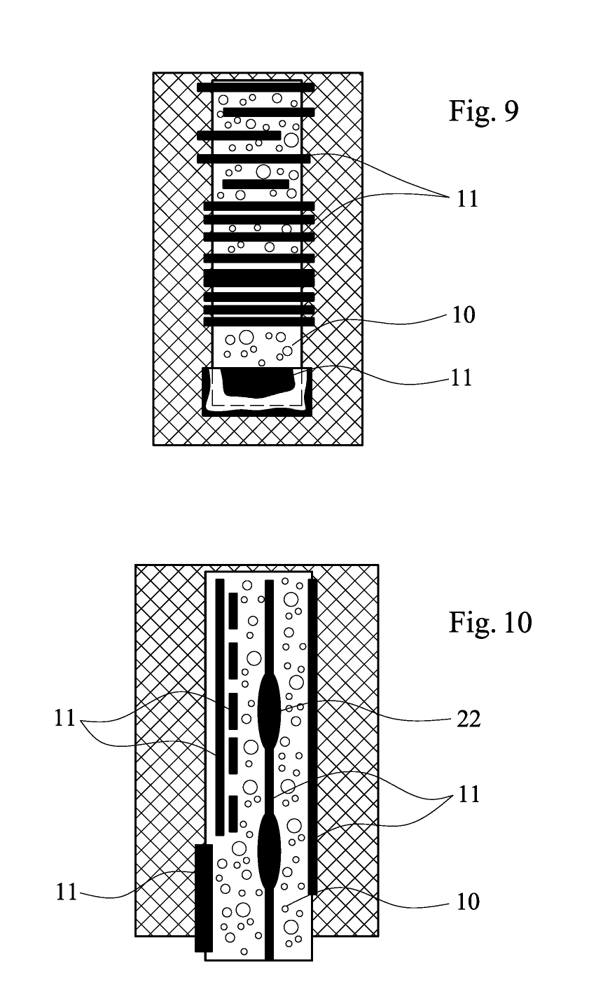

FIG. 9 again shows a strip pattern, wherein the individual strips are aligned transverse to the circumferential direction of the pneumatic vehicle tire 1 and some project laterally beyond the bonding agent area of the absorber 10. In addition, the barcode-like pattern of the line of the bonding agent 11 in FIG. 9 has different distances between the lines and some of the lines of the bonding agent 11 are laterally offset from one another. The lower part of the image in FIG. 9 illustrates a broadened region of the bonding agent 11 provided in the region of the abutting edges of the absorber 10, i.e. at the faces of the absorber 10 that come to rest against one another after it has been introduced into the pneumatic vehicle tire 1.

FIG. 10 shows various options for the execution of a strip pattern in circumferential direction of the pneumatic vehicle tire 1. These may have different lateral distances from one another, may have thickenings 22, may likewise be applied beyond the bonding agent area of the absorber 10 and/or may have interruptions. The strip of the bonding agent 11 which is apparent on the right-hand side of the image in FIG. 10 goes beyond the edge region of the absorber 10 in the lateral direction and is executed in a completely continuous manner in this section, which has the major benefit that this critical edge region of the absorber 10 that has a tendency to detachment is fixed in a particular manner on the inner surface 9 of the pneumatic vehicle tire 1.

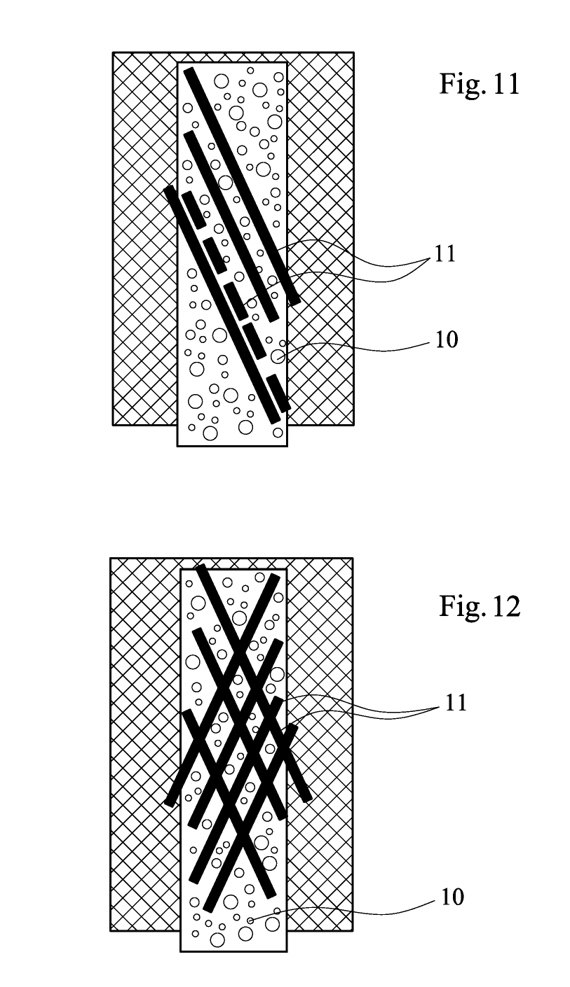

A further example of the line configuration of the bonding agent 11 is apparent from FIG. 11. In this case, the lines of the bonding agent 11 were arranged such that they run obliquely across the inner surface 9 of the pneumatic vehicle tire 1, i.e. at an angle to the circumferential direction of the pneumatic vehicle tire 1. It is also apparent from this diagram that the distances between the lines of the bonding agent 11 may have different widths and, in addition, interruptions within the line are possible.

FIG. 12 shows a crossed arrangement of the lines of the bonding agent 11 with some variation in distances between them.

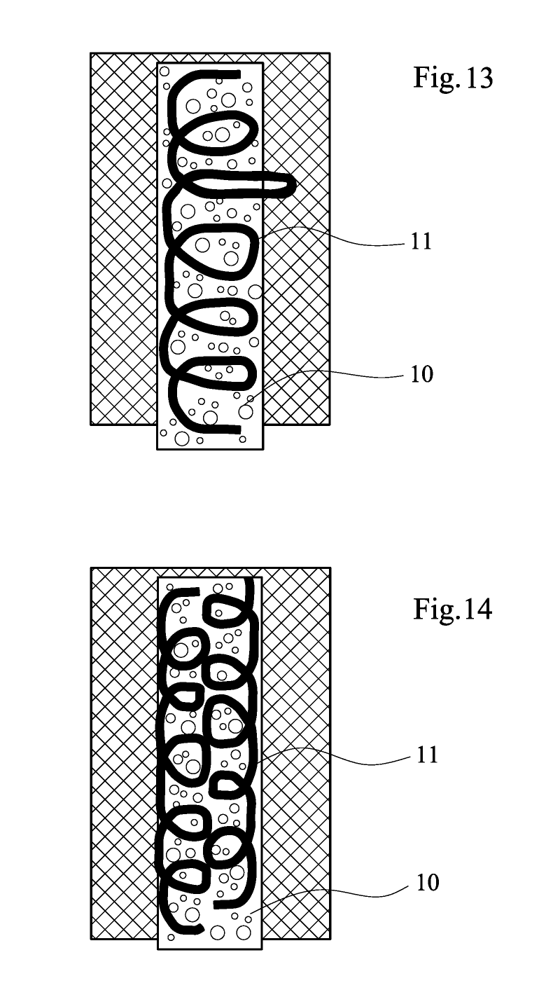

FIG. 13 once again illustrates a wiggly line form of the bonding agent 11 along the inner surface 9 of the pneumatic vehicle tire 1. The special feature here is that the line does not follow any particular geometry and, furthermore, parts of the lines of the bonding agent 11 are applied beyond the edge of the absorber.

As apparent from FIG. 14, viewed in circumferential direction of the pneumatic vehicle tire 1, it is also possible for multiple wiggly line forms of the bonding agent 11 to be provided alongside one another.

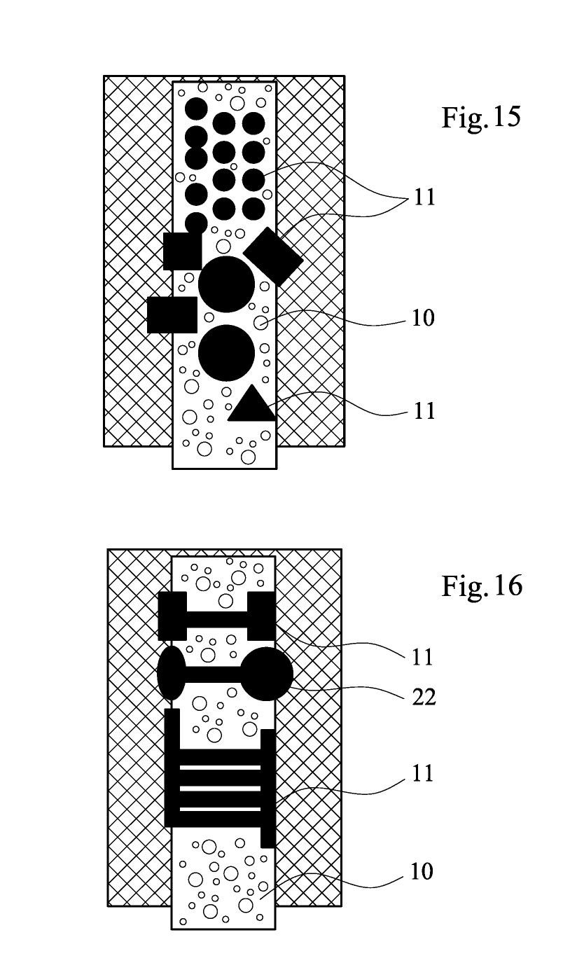

By way of example, FIG. 15 additionally shows a combination of a dot pattern with diamond- or square-shaped geometries of the bonding agent 11, wherein the individual patterns of the bonding agent 11 can also be used separately and the illustrated combination need not necessarily be employed.

FIG. 16 additionally shows a special feature, which is that thickenings 22 may be provided in each case in the side regions of the absorber 10, which assure improved adhesion to the pneumatic vehicle tire 1 in the edge region of the absorber 10.

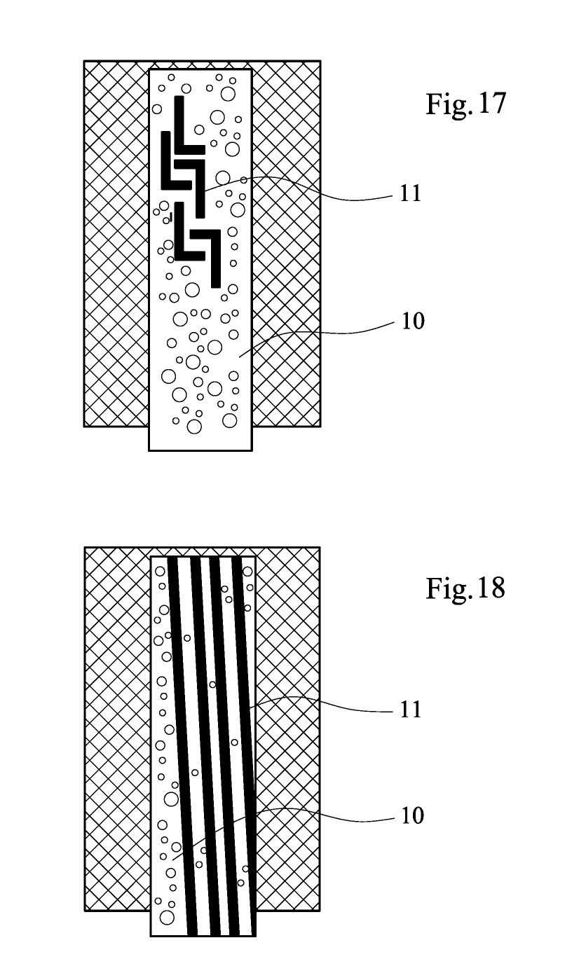

The scope of the invention also includes an execution variant of the line arrangement of the bonding agent 11 as apparent from FIG. 17. In this case, a kind of “Greek pattern” of the line arrangement of the bonding agent 11 has been applied to the inner surface 9 of the pneumatic vehicle tire 1.

Finally, FIG. 18 once again shows an oblique line arrangement of the bonding agent 11 in which continuous lines are used, between which there are varying lateral distances.

In all the execution variants of the bonding agent distribution that are shown in FIGS. 1 to 18, it is likewise possible, in each of the geometries of the bonding agent 11, also to provide interruptions in the lines or to change the thickness of the application of the bonding agent 11 in the direction of bonding agent application.

### LIST OF REFERENCE NUMERALS

1 Pneumatic vehicle tire

2 Tread

3 Sidewall

4 Sidewall

5 Tire bead

6 Tire bead

7 Wheel rim

8 Vehicle wheel

9 Inner surface

10 Absorber

11 Bonding agent

12 Valve

13 Valve shank

14 Wheel rim edge

15 Belt plies

16 Reinforcing profile

17 Carcass

18 Core profile

19 Bead core

20 Free surface area (of the absorber)

21 Air cavity

22 Thickening

1.-12. (canceled)

13. A pneumatic vehicle tire comprising a profiled tread that merges at either side into sidewalls, the profiled tread comprising ends formed by a tire bead which is insertable in an airtight manner into a wheel rim of a vehicle wheel, wherein an absorber cohesively bonded to an inner surface of the pneumatic vehicle tire has been integrated into the pneumatic vehicle tire for sound absorption, and wherein the absorber is cohesively bonded to the inner surface by a cohesive bonding comprising a bonding agent which is not distributed over a full area between the absorber and the inner surface of the pneumatic vehicle tire; and,
wherein the bonding agent has an inhomogeneous, varying distribution around a circumference of the inner surface of the pneumatic vehicle tire.

14. The pneumatic vehicle tire as claimed in claim 13, wherein the bonding agent comprises a strip pattern which takes the form of wavy lines or forms a dot matrix.

15. The pneumatic vehicle tire as claimed in claim 13, wherein total area of the bonding agent between the inner surface of the pneumatic vehicle tire and the absorber is between 10% and 90% of a projected area of the absorber.

16. The pneumatic vehicle tire as claimed in claim 13, wherein total area of the bonding agent between the inner surface of the pneumatic vehicle tire and the absorber is between 30% and 70% of a projected area of the absorber.

17. The pneumatic vehicle tire as claimed in claim 13, wherein the bonding agent is applied within a projected area of the absorber and beyond.

18. The pneumatic vehicle tire as claimed in claim 13, wherein a ratio f(x) of bonding agent area to projected area in every area component X*Y conforms to the following function:
$$f ( x ) = \frac{1}{2} {\sum }_{n = 0}^{m} ( {a}_{n} \frac{{x}^{n}}{{U}^{n}} + \frac{{b}_{n}}{2} ( 1 + sin \frac{{u}_{n} x}{U} ) + {c}_{n} {e}^{- {v}_{n} \frac{x}{U}} ) / {\sum }_{n = 0}^{m} ( {a}_{n} + {b}_{n} + {c}_{n} ) ++ \frac{1}{2} {\sum }_{n = 0}^{m} ( {g}_{n} \frac{{y}^{n}}{{B}^{n}} + \frac{{h}_{n}}{2} ( 1 + sin \frac{{j}_{n} y}{B} ) + {i}_{n} {e}^{- {k}_{n} \frac{y}{B}} ) / {\sum }_{n = 0}^{m} ( {g}_{n} + {h}_{n} + {i}_{n} )$$
wherein X and Y are coordinates in a circumferential direction and transverse direction of the pneumatic vehicle tire and:
0<=X<=U
0<=Y<=B
0<=x<=U
0<=y<=B
Vn>0.

19. A pneumatic vehicle tire comprising a profiled tread that merges at either side into sidewalls, the profiled tread comprising ends formed by a tire bead which is insertable in an airtight manner into a wheel rim of a vehicle wheel, wherein an absorber cohesively bonded to an inner surface of the pneumatic vehicle tire has been integrated into the pneumatic vehicle tire for sound absorption, wherein the absorber is cohesively bonded to the inner surface by a cohesive bonding comprising a bonding agent which is not distributed over a full area between the absorber and the inner surface of the pneumatic vehicle tire, and wherein the bonding agent is applied within a projected area of the absorber and beyond.

20. The pneumatic vehicle tire as claimed in claim 19, wherein the bonding agent has a homogeneously repeating distribution around the circumference of the inner surface of the pneumatic vehicle tire.

21. The pneumatic vehicle tire as claimed in claim 19, wherein the bonding agent has an inhomogeneous, varying distribution around the circumference of the inner surface of the pneumatic vehicle tire.

22. The pneumatic vehicle tire as claimed in claim 19, wherein the bonding agent comprises a strip pattern which takes the form of wavy lines or forms a dot matrix.

23. The pneumatic vehicle tire as claimed in claim 19, wherein total area of the bonding agent between the inner surface of the pneumatic vehicle tire and the absorber is between 10% and 90% of a projected area of the absorber.

24. The pneumatic vehicle tire as claimed in claim 19, wherein total area of the bonding agent between the inner surface of the pneumatic vehicle tire and the absorber is between 30% and 70% of a projected area of the absorber.

25. The pneumatic vehicle tire as claimed in claim 19, wherein a ratio f(x) of bonding agent area to projected area in every area component X*Y conforms to the following function:
$$f ( x ) = \frac{1}{2} {\sum }_{n = 0}^{m} ( {a}_{n} \frac{{x}^{n}}{{U}^{n}} + \frac{{b}_{n}}{2} ( 1 + sin \frac{{u}_{n} x}{U} ) + {c}_{n} {e}^{- {v}_{n} \frac{x}{U}} ) / {\sum }_{n = 0}^{m} ( {a}_{n} + {b}_{n} + {c}_{n} ) ++ \frac{1}{2} {\sum }_{n = 0}^{m} ( {g}_{n} \frac{{y}^{n}}{{B}^{n}} + \frac{{h}_{n}}{2} ( 1 + sin \frac{{j}_{n} y}{B} ) + {i}_{n} {e}^{- {k}_{n} \frac{y}{B}} ) / {\sum }_{n = 0}^{m} ( {g}_{n} + {h}_{n} + {i}_{n} )$$
wherein X and Y are coordinates in a circumferential direction and transverse direction of the pneumatic vehicle tire and:
0<=X<=U
0<=Y<=B
0<=x<=U
0<=y<=B
Vn>0.

26. A pneumatic vehicle tire comprising a profiled tread that merges at either side into sidewalls, the profiled tread comprising ends formed by a tire bead which is insertable in an airtight manner into a wheel rim of a vehicle wheel, wherein an absorber cohesively bonded to an inner surface of the pneumatic vehicle tire has been integrated into the pneumatic vehicle tire for sound absorption, and wherein the absorber is cohesively bonded to the inner surface by a cohesive bonding comprising a bonding agent which is not distributed over a full area between the absorber and the inner surface of the pneumatic vehicle tire; and,
wherein a ratio f(x) of bonding agent area to projected area in every area component X*Y conforms to the following function:
$$f ( x ) = \frac{1}{2} {\sum }_{n = 0}^{m} ( {a}_{n} \frac{{x}^{n}}{{U}^{n}} + \frac{{b}_{n}}{2} ( 1 + sin \frac{{u}_{n} x}{U} ) + {c}_{n} {e}^{- {v}_{n} \frac{x}{U}} ) / {\sum }_{n = 0}^{m} ( {a}_{n} + {b}_{n} + {c}_{n} ) ++ \frac{1}{2} {\sum }_{n = 0}^{m} ( {g}_{n} \frac{{y}^{n}}{{B}^{n}} + \frac{{h}_{n}}{2} ( 1 + sin \frac{{j}_{n} y}{B} ) + {i}_{n} {e}^{- {k}_{n} \frac{y}{B}} ) / {\sum }_{n = 0}^{m} ( {g}_{n} + {h}_{n} + {i}_{n} )$$
wherein X and Y are coordinates in a circumferential direction and transverse direction of the pneumatic vehicle tire and:
0<=X<=U
0<=Y<=B
0<=x<=U
0<=y<=B
Vn>0.

27. The pneumatic vehicle tire as claimed in claim 26, wherein the bonding agent has a homogeneously repeating distribution around the circumference of the inner surface of the pneumatic vehicle tire.

28. The pneumatic vehicle tire as claimed in claim 26, the bonding agent has an inhomogeneous, varying distribution around the circumference of the inner surface of the pneumatic vehicle tire.

29. The pneumatic vehicle tire as claimed in claim 26, wherein the bonding agent comprises a strip pattern which takes the form of wavy lines or forms a dot matrix.

30. The pneumatic vehicle tire as claimed in claim 26, wherein total area of the bonding agent between the inner surface of the pneumatic vehicle tire and the absorber is between 10% and 90% of a projected area of the absorber.

31. The pneumatic vehicle tire as claimed in claim 26, wherein total area of the bonding agent between the inner surface of the pneumatic vehicle tire and the absorber is between 30% and 70% of a projected area of the absorber.

32. The pneumatic vehicle tire as claimed in claim 26, wherein the bonding agent is applied within a projected area of the absorber and beyond.
